(19) United States
(12) Patent Application Publication
(10) Pub. No.: US 2010/0129598 A1
(43) Pub. Date: May 27, 2010

(54) OPTICAL FILM

(75) Inventors: Wen-Lung Su, Nantou County (TW); Tse-Min Mao, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: LIGHTHOUSE TECHNOLOGY CO., LTD, Hsinchu County (TW)

(21) Appl. No.: 12/371,899

(22) Filed: Feb. 16, 2009

(30) Foreign Application Priority Data
Nov. 27, 2008 (TW) 97146031

(51) Int. Cl. B32B 3/12; B32B 9/00

(52) U.S. Cl. 428/116; 428/690

(57) ABSTRACT

An optical film includes a number of phosphor layers. The phosphor layers are stacked together, and each of the phosphor layers is excited by an exciting light source and respectively emits a secondary light beam. The secondary light beams emitted by the phosphor layers are in different wavelength ranges.

### CROSS-REFERENCE TO RELATED APPLICATION

This application claims the priority benefit of Taiwan application serial no. 97146031, filed Nov. 27, 2008. The entirety of the above-mentioned patent application is hereby incorporated by reference herein and made a part of specification.

### BACKGROUND OF THE INVENTION

1. Field of the Invention

The present invention generally relates to an optical film, and more particularly relates to an optical film which has satisfactory quality and is easy to adjust.

2. Description of Related Art

With progress in semiconductor technologies, a light emitting diode (LED) now has advantages of high luminance, low power consumption, compactness, low driving voltage, mercury free, and so forth. Therefore, the LED has been extensively applied in the field of displays and illumination. On account of the extended applications of the LED, demands on colors of a light source supplied by the LED are diversified by degrees. In addition to the above, high quality requirements for correlated color temperature (CCT) and color rending index (CRI) in the LED have been growing.

Taiwan patent no. M318797 is directed to a method of forming an optical film. FIG. 1 is a schematic view of a conventional LED package structure having an optical film. The LED package structure 100 includes a substrate 110, an LED chip 120, a lens 130, and an optical film 140. The substrate 110 has a cavity 112 and a circuit layer 114. The LED chip 120 is disposed on the substrate 110 and is electrically connected to the circuit layer 114 on the substrate 110 through wire bonding. The optical film 140 is disposed above the cavity 112 of the substrate 110, and the lens 130 is disposed on the optical film 140. Here, the optical film 140 is formed by well mixing phosphor powder with transparent adhesive liquid or a transparent plastic material in an appropriate proportion and shaping the mixture as a film.

The phosphor powder in the optical film 140 excited by light emitted from the LED chip 120 generates secondary light beams. The secondary light beams can be mixed with the light emitted from the LED chip, so as to form other light beams with specific wavelengths. Hence, diverse light beams can be emitted by the LED package structure 100. Nonetheless, during the fabrication of the optical film 140, it is not apt to evenly mix the phosphor powder or to prevent precipitation of the phosphor powder. As such, the optical film 140 with poor quality may deteriorate CCT and CRI performance of the light emitted by the LED package structure 100. In other words, the optical film plays a dominant role in determining light source performance in the LED package structure.

### SUMMARY OF THE INVENTION

The present invention is directed to an optical film having a plurality of phosphor layers stacked together.

The present invention is directed to another optical film having a plurality of patterned phosphor layers arranged in array.

In the present invention, an optical film including a plurality of phosphor layers stacked together is provided. Each of the phosphor layers is excited by an exciting light source and respectively emits a secondary light beam, and the secondary light beams emitted by the phosphor layers are in different wavelength ranges. In a preferred embodiment of the present invention, the optical film is capable of peeling off or separating from an object (e.g. a substrate, a tape, and so on).

According to an embodiment of the present invention, the optical film further includes a first substrate on which the phosphor layers are stacked.

According to an embodiment of the present invention, a wavelength of the exciting light source is shorter than a wavelength of each of the secondary light beams.

According to an embodiment of the present invention, the first substrate is a transparent substrate. According to other embodiments of the present invention, the first substrate is a reflective substrate.

According to an embodiment of the present invention, the phosphor layers include at least two of a red phosphor layer, a green phosphor layer, and a yellow phosphor layer.

According to an embodiment of the present invention, one of the phosphor layers located bottommost entirely covers a surface of the first substrate.

According to an embodiment of the present invention, the optical film further includes a second substrate covering one of the phosphor layers located topmost, such that the phosphor layers are interposed between the first substrate and the second substrate.

According to an embodiment of the present invention, when the first substrate is a transparent substrate, the second substrate can be a transparent substrate or a reflective substrate. According to other embodiments of the present invention, when the first substrate is a reflective substrate, the second substrate can be a transparent substrate.

In the present invention, another optical film including a plurality of patterned phosphor layers arranged in array is provided. Each of the patterned phosphor layers is excited by an exciting light source and respectively emits a secondary light beam, and the secondary light beams emitted by the patterned phosphor layers are in different wavelength ranges.

According to an embodiment of the present invention, the optical film further includes a first substrate on which the patterned phosphor layers are stacked.

According to an embodiment of the present invention, a wavelength of the exciting light source is shorter than a wavelength of each of the secondary light beams.

According to an embodiment of the present invention, the first substrate is a transparent substrate. According to other embodiments of the present invention, the first substrate is a reflective substrate.

According to an embodiment of the present invention, the patterned phosphor layers include at least two of a patterned red phosphor layer, a patterned green phosphor layer, and a patterned yellow phosphor layer.

According to an embodiment of the present invention, the patterned phosphor layers cover different regions on a surface of the first substrate, and the patterned phosphor layers entirely cover the surface of the first substrate.

According to an embodiment of the present invention, the optical film further includes a second substrate. The second substrate covers the patterned phosphor layers, such that the patterned phosphor layers are interposed between the first substrate and the second substrate.

According to an embodiment of the present invention, when the first substrate is a transparent substrate, the second substrate can be a transparent substrate or a reflective substrate. On the contrary, when the first substrate is a reflective substrate, the second substrate is a transparent substrate.

According to an embodiment of the present invention, the patterned phosphor layers have a matrix arrangement.

According to an embodiment of the present invention, the patterned phosphor layers have a delta arrangement.

According to an embodiment of the present invention, the patterned phosphor layers have a honeycomb arrangement.

In light of the foregoing, the optical film of the present invention has a plurality of stacked phosphor layers or a plurality of patterned phosphor layers arranged in array. Each of the phosphor layers excited by the exciting light source respectively emits one secondary light beam, and the secondary light beams emitted by the phosphor layers are in different wavelength ranges. The secondary light beams in different wavelength ranges can be mixed and then can become the light beams in specific wavelength ranges. Moreover, it is easier to adjust the optical film having a plurality of phosphor layers, and therefore the light beams formed thereby have diverse wavelength lengths.

In order to make the aforementioned and other features and advantages of the present invention more comprehensible, several embodiments accompanied with figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic view of a conventional LED package structure having an optical film.

FIGS. 2A to 2E are schematic flowcharts illustrating a fabricating process of an optical film according to an embodiment of the present invention.

FIG. 3 is a schematic view illustrating another coating method with use of phosphor powder according to the embodiment of the present invention.

FIGS. 4A to 4D are schematic flowcharts illustrating a fabricating method of an optical film according to another embodiment of the invention.

FIGS. 5A and 5B are top views illustrating patterns on two types of patterned phosphor layers according to an embodiment of the present invention.

FIG. 6 is a schematic view of an LED package structure according to still another embodiment of the present invention.

FIG. 7 is a schematic view of an LED package structure according to yet still another embodiment of the present invention.

FIG. 8 is a schematic view of an LED package structure according to yet still another embodiment of the present invention.

FIG. 9 is a schematic view of an LED package structure according to yet still another embodiment of the present invention.

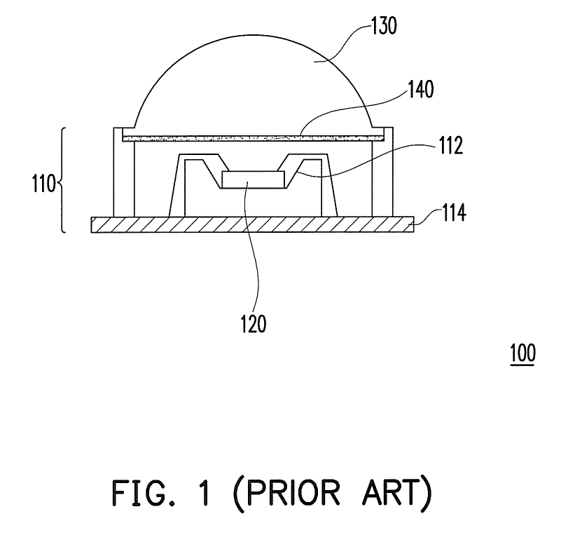

### DESCRIPTION OF EMBODIMENTS

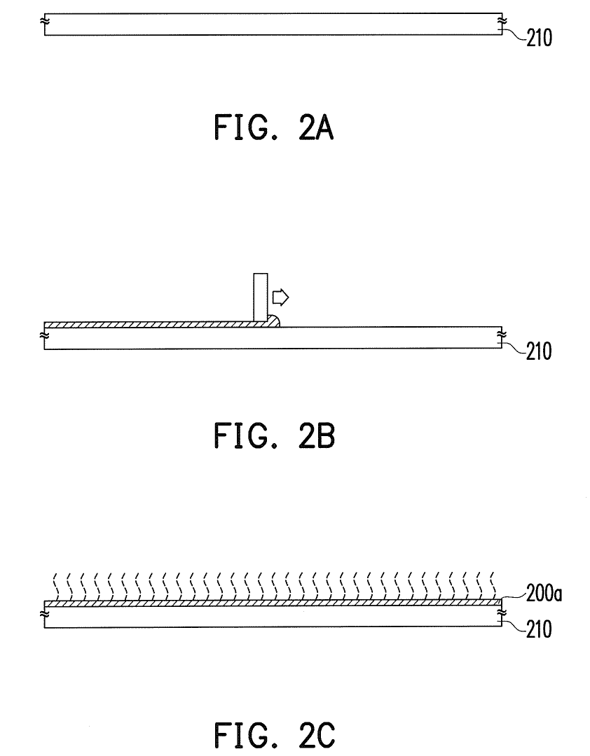

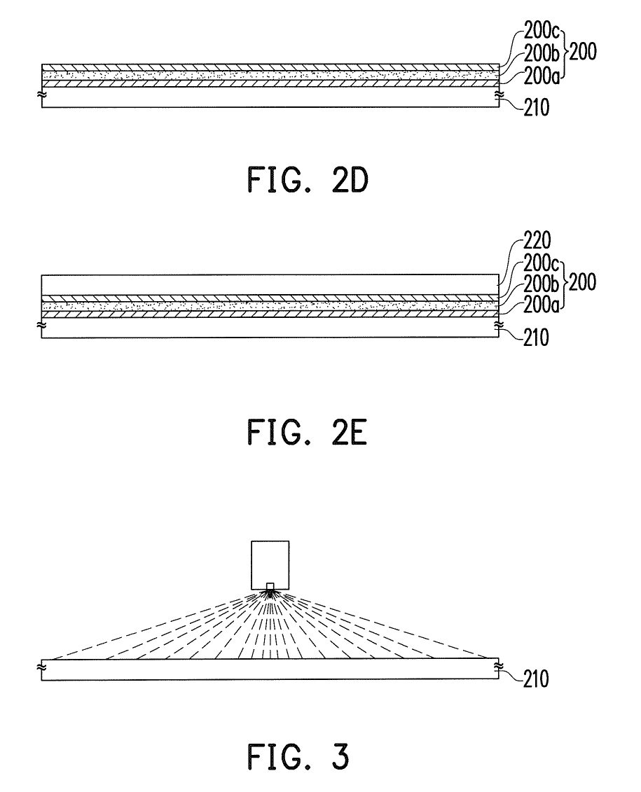

FIGS. 2A to 2E are schematic flowcharts illustrating a fabricating process of an optical film according to an embodiment of the present invention. First, referring to FIG. 2A, a first substrate 210 is provided. In the present embodiment, the first substrate 210 can be a transparent substrate or a reflective substrate. In addition, the first substrate 210 can be a rigid substrate or a flexible substrate.

Next, referring to FIG. 2B, phosphor powder and a volatile solvent are well mixed, and the first substrate 210 is coated with the mixture. In the present embodiment, a coating method of the first substrate 210 with the phosphor powder includes evenly distributing the mixture of the phosphor powder and the solvent onto the first substrate 210 by printing, as shown in FIG. 2B.

After that, referring to FIG. 2C, a phosphor layer 200a is formed by the residual phosphor powder after the solvent is evaporated. Based on actual demands, the steps depicted in FIGS. 2B and 2C can be repeated, so as to form a plurality of phosphor layers 200a, 200b, 200c, for example. Note that the order of forming the phosphor layers 200a, 200b, 200c and the thickness of the phosphor layers 200a, 200b, 200c are not limited in the present invention and can be changed upon actual requirements. In the present embodiment shown in FIG. 2D, only three phosphor layers 200a, 200b, and 200c are illustrated for the purpose of exemplary explanation. The thickness of the phosphor layers 200a, 200b, and 200c preferably ranges from 0.5 μm to 1 mm in the present embodiment.

Referring to FIG. 2E, after the aforesaid steps are completed, a second substrate 220 can be selectively disposed on the topmost phosphor layer 200c, such that all of the phosphor layers 200a, 200b, and 200c are interposed between the first substrate 210 and the second substrate 220. The second substrate 220 serves to protect the phosphor layers 200a, 200b, and 200c from being damaged. In the present embodiment, the second substrate 220 is, for example, a reflective substrate or a transparent substrate. Besides, the second substrate 220 can be a rigid substrate or a flexible substrate. It should be noted that when the first substrate 210 is a transparent substrate, the second substrate 220 can be either a reflective substrate or a transparent substrate. By contrast, when the first substrate 210 is a reflective substrate, the second substrate 220 can be a transparent substrate.

Alternatively, the phosphor layers 200a, 200b, and 200c can be peeled off or released from the first substrate 210 after said steps are completely performed according to the present embodiment, so as to form the optical film 200 having a plurality of phosphor layers 200a, 200b, and 200c. To be more specific, without the first substrate 210 and the second substrate 220, the optical film 200 simply consisting of the phosphor layers 200a, 200b, and 200c is more advantageous in terms of thickness, weight, and volume. In a preferred embodiment of the present invention, the optical film 200 is capable of peeling off or separating from an object (e.g. a substrate, a tape, and so on).

FIG. 3 is a schematic view illustrating another coating method with use of the phosphor powder according to the present embodiment of the present invention. Referring to FIG. 3, the first substrate 210 can be coated with the phosphor powder not only by printing as shown in FIG. 2B but also by spraying the phosphor powder. Note that the thickness of the phosphor layers can vary upon the actual demands no matter the coating method is performed by printing or by spraying. In the present embodiment, the thickness of the phosphor layer preferably ranges from 0.5 μm and 1 mm.

Afterwards, referring to FIG. 2E, the optical film formed by performing the aforesaid manufacturing process includes a plurality of phosphor layers 200a, 200b, and 200c stacked together. Each of the phosphor layers 200a, 200b, and 200c is excited by an exciting light source and respectively emits one secondary light beam, and the secondary light beams emitted by the phosphor layers 200a, 200b, and 200c are in different wavelength ranges. In general, a wavelength of the exciting light source is shorter than a wavelength of each of the secondary light beams. According to the present embodiment, the phosphor layer 200a is a red phosphor layer, the phosphor layer 200b is a green phosphor layer, and the phosphor layer 200c is a yellow phosphor layer, for example. Each of the phosphor layers 200a, 200b, and 200c respectively has different phosphor powder. In the present embodiment, the wavelength within which the phosphor layers 200a, 200b, and 200c can be excited ranges from 380 nm to 700 nm, for example.

The thickness of the phosphor layers 200a, 200b, and 200c in the optical film 200 poses an impact on optical properties of the optical film 200. Therefore, the optical properties of the optical film 200 can be changed by controlling the thickness of the phosphor layers 200a, 200b, and 200c.

The optical film 200 of the present embodiment can include a first substrate 210 for enhancing the structural strength of the optical film 200, such that the optical film 200 can be used with ease. The bottommost phosphor layer 200a entirely covers a surface of the first substrate 210. In addition to the first substrate 210, the optical film 200 can further include a second substrate 220, so as to better protect the optical film 200 from being damaged. The second substrate 200 covers the topmost phosphor layer 200c, such that the phosphor layers 200a, 200b, and 200c are interposed between the first substrate 210 and the second substrate 220. Materials of the first substrate 210 and the second substrate 220 and conditions on which said materials can be used have been discussed hereinbefore, and therefore no further descriptions are provided herein.

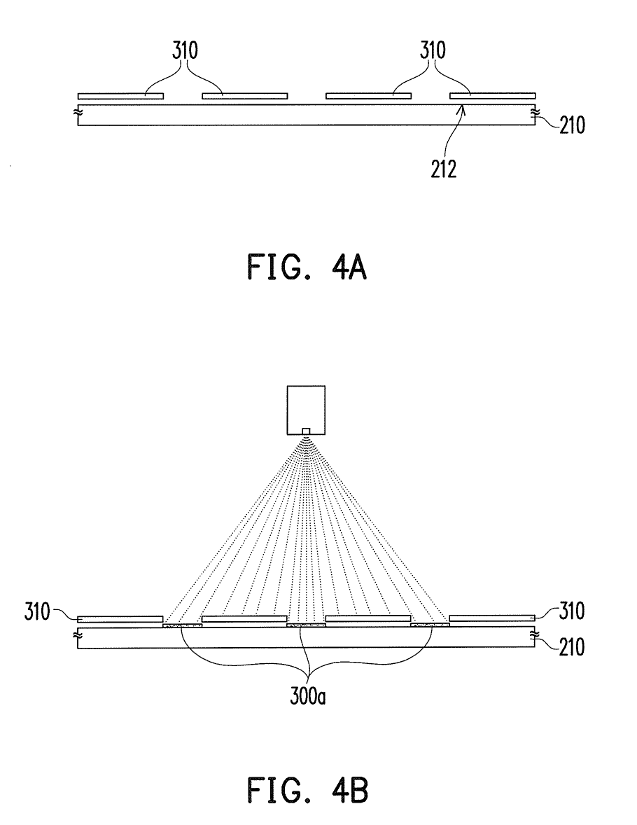

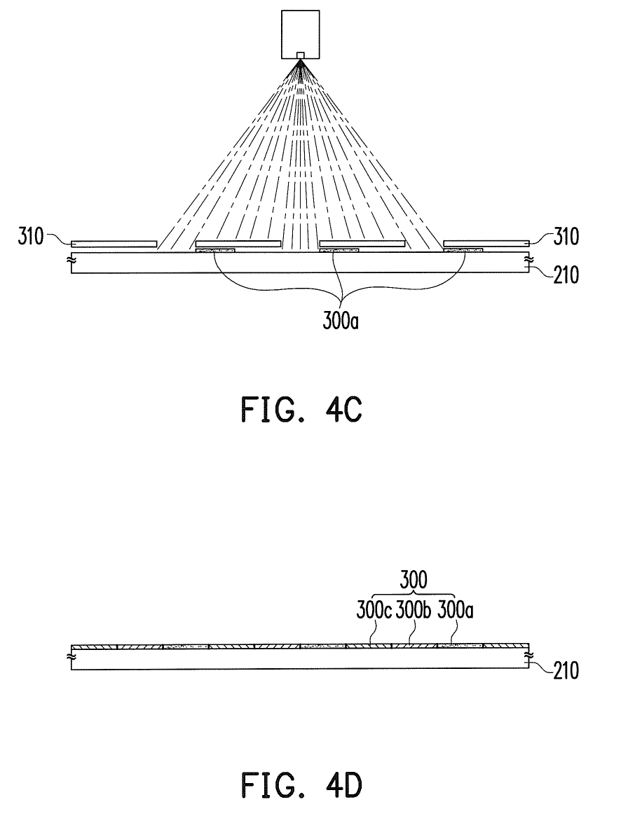

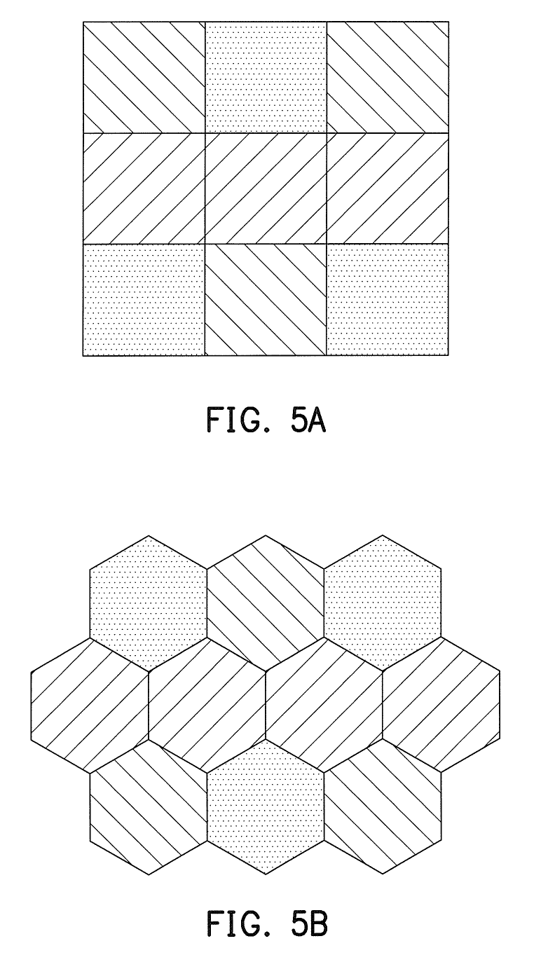

FIGS. 4A to 4D are schematic flowcharts illustrating a fabricating method of an optical film according to another embodiment of the invention. Referring to FIG. 4A, the fabricating method of the optical film in the present embodiment is similar to that depicted in FIGS. 2A to 2D, while the main difference therebetween lies in that a patterned mask layer 310 is disposed on the first substrate 210 before the first substrate 210 is coated with the phosphor powder, so as to partially expose portions of a surface 212 of the first substrate 210.

As indicated in FIG. 4B, the exposed portions of the surface 212 of the first substrate 210 are coated with the phosphor powder, so as to form a patterned phosphor layer 300a. The other portions of the surface 212 of the first substrate 210 that are covered by the mask layer 310 do not contain any phosphor powder.

With reference to FIG. 4C, the mask layer 310 is moved to expose portions of the surface 212 of the first substrate 210. Note that the portions of the surface 212 of the first substrate 210 where the patterned phosphor layer 300a is formed are covered by the mask layer 310.

Next, the step depicted in FIG. 4B is repeated by coating the first substrate 210 with another phosphor powder, so as to form another patterned phosphor layer 300b. In the present embodiment, the steps depicted in FIGS. 4B and 4C can be repeated continuously without restraint, and thereby a plurality of patterned phosphor layers 300a, 300b, and 300c arranged in array as shown in FIG. 4D can be formed. In FIG. 4D, only three different patterned phosphor layers 300a, 300b, and 300c are illustrated for the purpose of exemplification.

Similar to the manufacturing method of the optical film described in the previous embodiment, steps of the manufacturing method of the optical film in the present embodiment can also include selectively forming a second substrate 220 to cover the patterned phosphor layers 300a, 300b, and 300c and to further dispose the patterned phosphor layers 300a, 300b, and 300c between the first substrate 210 and the second substrate 220. In an alternative, according to other embodiments, the patterned phosphor layers 300a, 300b, and 300c can be peeled off or released from the first substrate 210, so as to form an optical film 300 which includes a plurality of patterned phosphor layers 300a, 300b, and 300c arranged in array.

Referring to FIG. 4D, the optical film 300 formed by applying the aforesaid manufacturing method includes a plurality of patterned phosphor layers 300a, 300b, and 300c arranged in array. Each of the patterned phosphor layers 300a, 300b, and 300c is excited by an exciting light source and emits a secondary light beam, and the secondary light beams emitted by the patterned phosphor layers 300a, 300b, and 300c are in different wavelength ranges. According to the present embodiment, a wavelength of the exciting light source is shorter than a wavelength of each of the secondary light beams. For instance, the patterned phosphor layer 300a of the present embodiment is a patterned red phosphor layer, the patterned phosphor layer 300b of the present embodiment is a patterned green phosphor layer, and the patterned phosphor layer 300c of the present embodiment is a patterned yellow phosphor layer. The thickness of the phosphor layers, areas covered by the phosphor layers, and positions where the phosphor layers cover are not limited in the present invention and can be changed based on actual demands. However, only three patterned phosphor layers 300a, 300b, and 300c are illustrated in FIG. 4A for the purpose of exemplification.

Referring to FIG. 4D, the optical film 300 of the present embodiment can include a first substrate 210 on which the patterned phosphor layers 300a, 300b, and 300c are stacked. In the present embodiment, the patterned phosphor layers 300a, 300b, and 300c cover different regions on the surface 212 of the first substrate 210.

FIGS. 5A and 5B are top views illustrating patterns on two types of patterned phosphor layers according to an embodiment of the present invention. Referring to FIGS. 5A and 5B, the patterned phosphor layers 300a, 300b, and 300c are formed according to the patterns on the mask layer 310, and therefore the patterned phosphor layers 300a, 300b, and 300c have different patterns. For instance, the patterned phosphor layers 300a, 300b, and 300c can have a matrix arrangement as indicated in FIG. 5A, a honeycomb arrangement as indicated in FIG. 5B, or a delta arrangement.

In the above embodiments, structures and manufacturing methods of the two types of optical films are respectively discussed. In the embodiment hereafter, the application of the aforesaid optical films to an LED package structure is elaborated with reference to drawings.

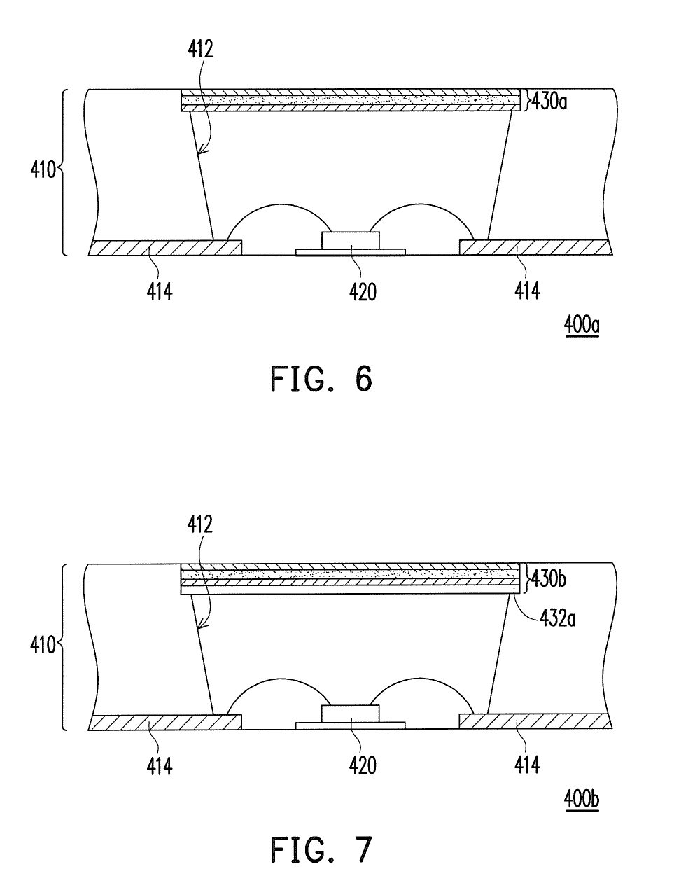

FIG. 6 is a schematic view of an LED package structure according to still another embodiment of the present invention. Referring to FIG. 6, an LED package structure 400a of the present embodiment includes a substrate 410, an LED chip 420, and an optical film 430a. The substrate 410 has a cavity 412 and a circuit layer 414, and the cavity 412 exposes a portion of the circuit layer 414. The LED chip 420 is disposed on the bottom of the cavity 412 and is electrically connected to the circuit layer 414. Here, the LED chip 420 and the circuit layer 414 are electrically connected by performing a wire bonding process or a flip chip process.

According to the present embodiment, the optical film 430a is referred to as the optical film 200 described in the above embodiment, for example. The optical film 430a includes a plurality of stacked phosphor layers. The stacked phosphor layers excited by an exciting light source emit secondary light beams in different wavelength ranges, and the secondary light beams in different wavelength ranges can be mixed to form the light beams in specific wavelength ranges.

In FIG. 6 of the present embodiment, only one LED chip 420 is illustrated for exemplification. Nevertheless, the number of the LED chip 420 and the wavelength of the light emitted by the LED chip 420 can be adjusted upon actual demands and are not limited in the present invention. Notably, the wavelength of the light emitted by the LED chip 420 is taken into account, and so are the light beams which are in different wavelength ranges and are emitted from different phosphor layers excited by the exciting light source. As such, it is rather easy to adjust the light emitted by the LED package structure 400a. In addition to the above, CCT and CRI performance of the light emitted by the LED package structure 400 can also be better regulated because the optical film 430a is rather apt to be adjusted.

FIG. 7 is a schematic view of an LED package structure according to yet still another embodiment of the present invention. As shown in FIG. 7, the LED package structure 400b of the present embodiment is similar to the LED package structure 400a of the previous embodiment. The main difference therebetween lies in that an optical film 430b of the present embodiment further includes a first substrate 432a.

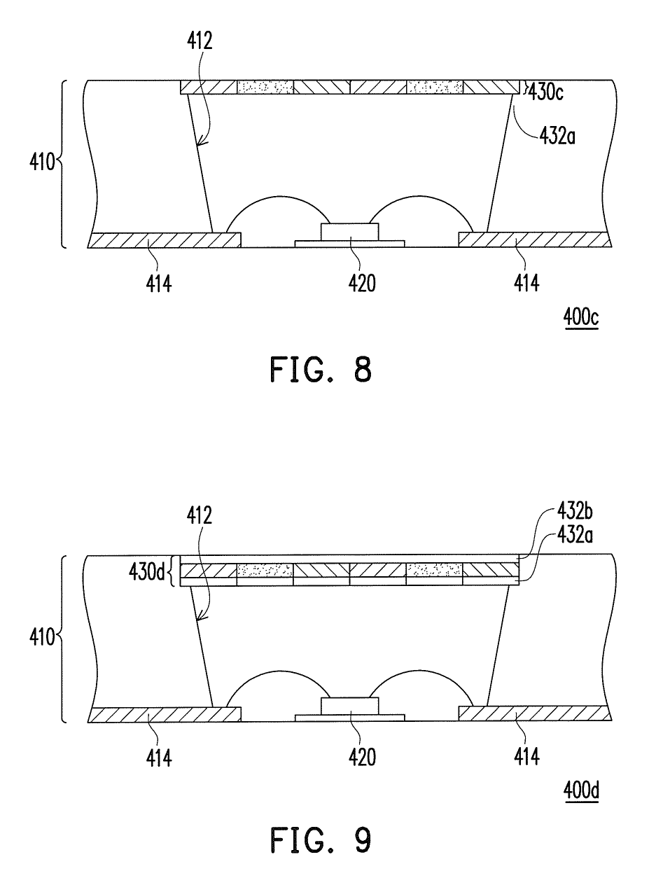

FIG. 8 is a schematic view of an LED package structure according to yet still another embodiment of the present invention. As shown in FIG. 8, the LED package structure 400c of the present embodiment is similar to the aforesaid LED package structure 400a. The main difference therebetween lies in that an optical film 430c in the LED package structure 400c of the present embodiment is, for example, the optical film 300 having a plurality of patterned phosphor layers arranged in array.

In FIG. 8 of the present embodiment, only one LED chip 420 is illustrated for exemplification. However, in a preferred embodiment, the LED chip 420 can be arranged corresponding to patterns on the optical film 430c, so as to form a plurality of sub-regions in which light beams can be mixed and can have different wavelengths, which is not limited in the present invention.

FIG. 9 is a schematic view of an LED package structure according to yet still another embodiment of the present invention. As shown in FIG. 9, the LED package structure 400d of the present embodiment is similar to the LED package structure 400c of the previous embodiment. The main difference therebetween lies in that an optical film 430d of the present embodiment further includes a first substrate 432a and a second substrate 432b. The first substrate 432a and the second substrate 432b serve to protect the optical film 430d from being damaged during fabrication thereof or consumers' utilization thereof

According to the above embodiments depicted in FIGS. 6 to 9, the LED chip 420 is taken as an example for describing the present invention. However, the above descriptions do not pose a limitation on the present invention. Namely, an LED package structure including a lens can also be disposed in the cavity 412, so as to form a package in package (PIP) structure. Besides, the LED chip 420 can also be replaced by other appropriate light emitting devices.

In light of the foregoing, the optical film of the present invention has a plurality of phosphor layers, and the phosphor layers are excited by the exciting light source and emit the secondary light beams in different wavelength ranges. The secondary light beams in different wavelength ranges can be mixed and then can become the light beams in specific wavelength ranges. Since the optical film is rather apt to be adjusted, the light beams formed thereby are allowed to have diverse wavelength lengths. Moreover, in some embodiments of the present invention, the light beams emitted by the LED package structure can have different CCTs and better CRIs when the optical film of the present invention is applied to the LED package structure.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical film, comprising:
a plurality of phosphor layers stacked together, wherein each of the phosphor layers is excited by an exciting light source and respectively emits a secondary light beam, and the secondary light beams emitted by the phosphor layers are in different wavelength ranges.

2. The optical film as claimed in claim 1, further comprising a first substrate on which the phosphor layers are stacked.

3. The optical film as claimed in claim 1, wherein a wavelength of the exciting light source is shorter than a wavelength of each of the secondary light beams.

4. The optical film as claimed in claim 2, wherein the first substrate is a transparent substrate.

5. The optical film as claimed in claim 2, wherein the first substrate is a reflective substrate.

6. The optical film as claimed in claim 1, wherein the phosphor layers comprise at least two of a red phosphor layer, a green phosphor layer, and a yellow phosphor layer.

7. The optical film as claimed in claim 2, wherein one of the phosphor layers located bottommost entirely covers a surface of the first substrate.

8. The optical film as claimed in claim 2, further comprising a second substrate, wherein the second substrate covers one of the phosphor layers located topmost, such that the phosphor layers are interposed between the first substrate and the second substrate.

9. The optical film as claimed in claim 8, wherein the first substrate is a transparent substrate, and the second substrate is a transparent substrate or a reflective substrate.

10. The optical film as claimed in claim 8, wherein the first substrate is a reflective substrate, and the second substrate is a transparent substrate.

11. The optical film as claimed in claim 1, wherein the optical film is capable of peeling off or separating from an object.

12. An optical film, comprising:
a plurality of patterned phosphor layers arranged in array, wherein each of the patterned phosphor layers is excited by an exciting light source and respectively emits a secondary light beam, and the secondary light beams emitted by the patterned phosphor layers are in different wavelength ranges.

13. The optical film as claimed in claim 12, further comprising a first substrate on which the patterned phosphor layers are stacked.

14. The optical film as claimed in claim 12, wherein a wavelength of the exciting light source is shorter than a wavelength of each of the secondary light beams.

15. The optical film as claimed in claim 13, wherein the first substrate is a transparent substrate.

16. The optical film as claimed in claim 13, wherein the first substrate is a reflective substrate.

17. The optical film as claimed in claim 12, wherein the patterned phosphor layers comprise at least two of a patterned red phosphor layer, a patterned green phosphor layer, and a patterned yellow phosphor layer.

18. The optical film as claimed in claim 13, wherein the patterned phosphor layers cover different regions on a surface of the first substrate, and the patterned phosphor layers entirely cover the surface of the first substrate.

19. The optical film as claimed in claim 13, further comprising a second substrate, wherein the second substrate covers the patterned phosphor layers, such that the patterned phosphor layers are interposed between the first substrate and the second substrate.

20. The optical film as claimed in claim 19, wherein the first substrate is a transparent substrate, and the second substrate is a transparent substrate or a reflective substrate.

21. The optical film as claimed in claim 19, wherein the first substrate is a reflective substrate, and the second substrate is a transparent substrate.

22. The optical film as claimed in claim 12, wherein the patterned phosphor layers have a matrix arrangement.

23. The optical film as claimed in claim 12, wherein the patterned phosphor layers have a delta arrangement.

24. The optical film as claimed in claim 12, wherein the patterned phosphor layers have a honeycomb arrangement.

25. The optical film as claimed in claim 12, wherein the optical film is capable of peeling off or separating from an object.
